(19) United States
(12) Patent Application Publication
(10) Pub. No.: US 2003/0167124 A1
(43) Pub. Date: Sep. 4, 2003

(54) Electronic tide tables

(76) Inventor: Dohn A. Bowden, Tewksbury, MA (US)

Correspondence Address: Dohn A. Bowden, 36 Marshall St., Tewksbury, MA, 01876-2626, US

(21) Appl. No.: 09/884,502

(22) Filed: Jun. 16, 2001

(51) Int. Cl. G06F 19/00

(52) U.S. Cl. 702/2

(57) ABSTRACT

An electronic tide tables comprising a tidal prediction program residing in memory of an electronic circuit capable of predicting and displaying tidal times, heights, date, time, and location of prediction for user selected localities on selected date and thereafter. Tidal prediction program uses the harmonic analysis method and associated harmonic data for predicting tides.

### BACKGROUND

1. Field of Invention

The present invention relates to devices for predicting ocean tides, specifically to continuously predict and display tide times and heights for the selected locality on the desired day, and thereafter.

2. Discussion of Prior Art

Currently to make tidal predictions one must use tide tables, mainframe or personal computer-based software, equipment that requires extensive data input, devices that have tidal tables either previously stored or require the user to store the information, or devices that use average tidal cycle periods resulting in approximate tidal predictions. These devices are not automatic, nor are they convenient to use.

To make tidal predictions which closely approximates the National Oceanic and Atmospheric Administration (NOAA) predictions one must use the “Harmonic Analysis” method as described in the “Manual Of Harmonic Analysis and Prediction of Tides” Special Publication No. 98 published by the U.S. Department of Commerce. The harmonic analysis of tides is based upon an assumption that the rise and fall of the tides in any locality can be expressed mathematically by the sum of a series of harmonic terms having certain relations to astronomical conditions. “Harmonic Analysis” method to predict tidal times and heights for any given locality is complex and labor intensive. From Special Publication 98 (paragraph 8) “Harmonic Analysis” as applied to tides is the process by which the observed tidal data at any place are separated into a number of harmonic constituents. The quantities sought are known as harmonic constants consisting of amplitudes and phases. Harmonic prediction is accomplished by reuniting the elementary constituents in accordance with astronomical relations prevailing at the time for which the predictions are made. Harmonic Analysis method uses astronomical data as well as harmonic constituents when predicting ocean tides.

There are many varieties of devices available to display tidal information. These devices do not use the “Harmonic Analysis” method. These devices, whether mechanical or electrical, use either a predetermined time period (typically twelve hours and twenty-five minutes, representing an average tidal cycle) or they store pre-calculated tide tables for locations of choice. The devices that use an average tidal cycle time require calibration by the user to set the proper point in the current tidal cycle using local information or National Oceanic and Atmospheric Administration (NOAA) tide tables. Examples of such devices may be found in U.S. Pat. No. 3,703,804 issued 1972, U.S. Pat. No. 4,035,167 issued 1977, U.S. Pat. No. 4,412,749 issued 1983, and U.S. Pat. No. 4,849,949 issued 1989. Devices that store tide tables data may be found in U.S. Pat. No. 5,299,126 issued 1994 and U.S. Pat. No. 5,347,497 issued 1994.

U.S. Pat. No. 5,115,417 issued 1992 employs both an average cycle time and data obtained from tidal tables.

U.S. Pat. No. 6,226,594 issued 2001 calculates a spring tide day. The spring tide and the neap tide are individually defined as the states of tides at full moon or the new moon and as the states of tide at the first and last quarters of the moon. The device described in U.S. Pat. No. 6,226,594 will determine the day on which the tide level difference is at its maximum between high and low tides in a particular geographical area. The device does not indicate the daily tidal high and low times nor does it indicate the high and low tidal heights. The spring tide day is useful for certain industries, however, it does not predict the daily values which are useful for other industries and recreations.

The display incorporated in these devices takes many forms. Many display the time to or from high and low tide in hours and minutes. Others have a more graphic display that is indicative of the relative height of the water as opposed to the time to the next tidal event. Many of these displays use motor-driven discs that move by a viewing window to create a display that changes with time. Other devices use electronic displays such as bar graph displays to indicate the relative water height.

In reality, the tidal interval, or time between consecutive tides, differs between every tidal cycle. The tidal cycle difference causes such devices that use a constant interval to predict the next tidal occurrence can be in error. To accurately determine the tidal cycle one must use the “Harmonic Analysis” method.

The height of each tidal occurrence is different. Devices that use a constant mechanism to display the height of the next tidal occurrence can be in error to the actual height.

All the tidal devices heretofore known suffer from a number of disadvantages:

(a) Many approximate the times and heights of tides by using a predetermined average cycle time, which results in predictions that may not match NOAA's predicted values.

(b) Others use preprogrammed tidal information that is retrieved from the device's memory. Information available for display will only be for the period of time covered by the data inputted. Other period of times will require the user or developer to enter additional information.

(c) They do not employ a means of predicting tidal times and heights using the “Harmonic Analysis” method, which results in predictions that may not match NOAA's predicted values.

(d) Devices that require a user to consult tidal tables, input technical data, and/or calibrate the device, become difficult for users to operate.

(e) Displays are often difficult to read and understand due to complex and sometimes obscure display devices.

(f) Average tidal cycle times are based only on the lunar harmonic constituents, effects of all the others are neglected. Average tidal times will not provide accurate tidal information as found in NOAA's tide tables. The result will only be an approximation.

(g) Reference to other tidal tables will be required to “set” or “calibrate” the devices to the correct point of the current tidal cycle. Periodic “re-setting” or “re-calibrating” will be required. Again, reference to other tidal tables will be necessary.

(h) Accuracy will vary from device to device. Those that use an average cycle time will have a large swing in accuracy, dependent upon where in the cycle the tides are being predicted. Those that store tidal information and later display a particular date's information will be as accurate as the tidal table referenced, unless an error was made in the input.

### OBJECTS AND ADVANTAGES

Accordingly, besides the objects and advantages of the electronic tide table described above in my patent, several objects and advantages of my invention are:

(a) to provide a device that is simple to use by persons of almost any age;

(b) to provide a reliable, accurate, standalone electronic device which will predict high and low tidal times and corresponding heights for the selected locality;

(c) to provide a program residing in flash memory which predicts tidal times and heights based on the “Harmonic Analysis” method of tidal predictions vice using average cycle time;

(d) to provide a means of setting a date for tidal prediction;

(e) to provide a means of setting the current time into a “Real Time Clock” (RTC);

(f) to provide a means of selecting a locality for which the tide times and heights will be predicted;

(g) to provide a means of displaying the predicted tidal times, heights, location, date, and current time in a manner that is simple to read and understand;

(h) to provide a means of storing or calculating all fundamental constants, formulas, and variables which are used in the computation of the tidal values thus eliminating the need to reference or include the tables contained in the “Manual of Harmonic Analysis and Prediction of Tides”;

(i) to provide a means of predicting tidal high and low times and corresponding heights to within minutes of NOAA's predicted values by simply selecting a date (month, day, year) and a location (all tidal tables will differ slightly from one another);

(j) to provide a means so that no user technical data input or reference to other tidal tables will be required other than setting time, date, and desired location for tidal prediction times and heights;

(k) to provide a means of having the device recalculate the predicted tidal times and heights when Daylight Saving Time (DST) begins or ends, or there is a change in date or location;

(l) to provide as part of the software “speed” data for each of the thirty seven harmonic constituents which will remain constant for all reference stations;

(m) to provide as part of the software “epoch” and “amplitude” data for each of the thirty seven harmonic constituents for each reference station;

(n) to provide as part of the software the values of NOAA's “Tidal Differences” and “Reference station” data for each locality intended for tidal predictions;

(o) to provide a device that can predict tidal times and heights for all dates constrained only by operating parameters of the Real Time Clock (RTC) and fundamental astronomical data within the tidal program;

(p) to provide tidal predictions based on all thirty seven harmonic constituents; and

(q) to provide a device that does not require the user to calibrate or set parameters, buttons, switches, etc. other than setting time, date, and desired location.

Further objects and advantages of my Electronic Tide Tables will become apparent from consideration of the drawings and ensuing description.

### SUMMARY

In accordance with the present invention comprising of a tidal prediction program residing in memory of an electronic circuit capable of predicting and displaying tidal times, heights, date, time, and location of prediction for plurality of localities on selected date and thereafter. Tidal prediction program uses the harmonic analysis method and associated harmonic data for predicting tides.

Device is structured such that a user will only be required to initially select date, current time, and desired locality for prediction. Once date, time, and location are set the device will update when date changes or user changes date, time, and/or location. All technical data required is contained within the program, therefore, user is not required to be versed in the technical matters of tidal predictions nor will they be required to reference other tidal information such as tables.

### DESCRIPTION OF DRAWINGS

FIG. 1 shows a block diagram of a basic microprocessor (or equivalent) based system.

FIG. 2 is a general flow chart which illustrates the software flow for the program stored in memory.

FIG. 3 shows block diagram of prototype system

FIG. 4 shows connections between J7 of development board and LCD module

FIG. 5 shows one of many possible form of display for predicted Tidal Times.

FIG. 6 shows one of many possible form of display for predicted Tidal Heights.

FIG. 7 shows LCD module incorporated into one of many possible cases.

LIST OF REFERENCE NUMERALS

| | | | |
|---|---|---|---|
| 10 | permanent memory | 12 | processor unit |
| | component | | |
| 14 | static RAM | 16 | crystal (Time/bate) |
| 18 | crystal (Main Clock) | 20 | display module |
| 22 | switch S1 | 24 | switch S2 |
| 26 | switch S3 | 28 | switch S4 |
| 30 | reset switch | 32 | data lines D0-D7 |
| 34 | address lines A0-A19 | 36 | display control lines |
| 38 | display data lines DB0-DB7 | 50 | PWR On |
| 52 | reset | 54 | initialize system |
| 56 | warning menu | 58 | user menu |
| 60 | calculate DST flow chart | 61 | calculate tidal constants |
| | block | | |
| 62 | calculate tides | 64 | display tides |
| 66 | S4 selected | 68 | S1 selected |
| 70 | evaluate date, time & location | 72 | year or location changed |
| 73 | day changed | 74 | DST changed |
| 76 | run user menu | 78 | display tide heights |
| 80 | display tides | 82 | calculate tidal constants |
| 84 | calculate tides | 86 | display tides |
| 100 | Jackrabbit Development | 102 | Jackrabbit board |
| | Board | | |
| 104 | connector J7 | 105 | cable |
| 106 | power input jack J1 | 108 | wall transformer |
| 110 | connector J4 | 112 | connector J5 |
| 114 | variable resistor R1 (0-10K) | 116 | resistor R2 (10K) |
| 120 | date | 122 | time |
| 124 | location | 126 | Hi morning and afternoon |
| | | | tidal times |
| 128 | Lo morning and afternoon | 130 | Hi morning and afternoon |
| | tidal times | | tidal heights |
| 132 | Lo morning and afternoon | | |
| | tidal heights | | |

### DESCRIPTION OF INVENTION

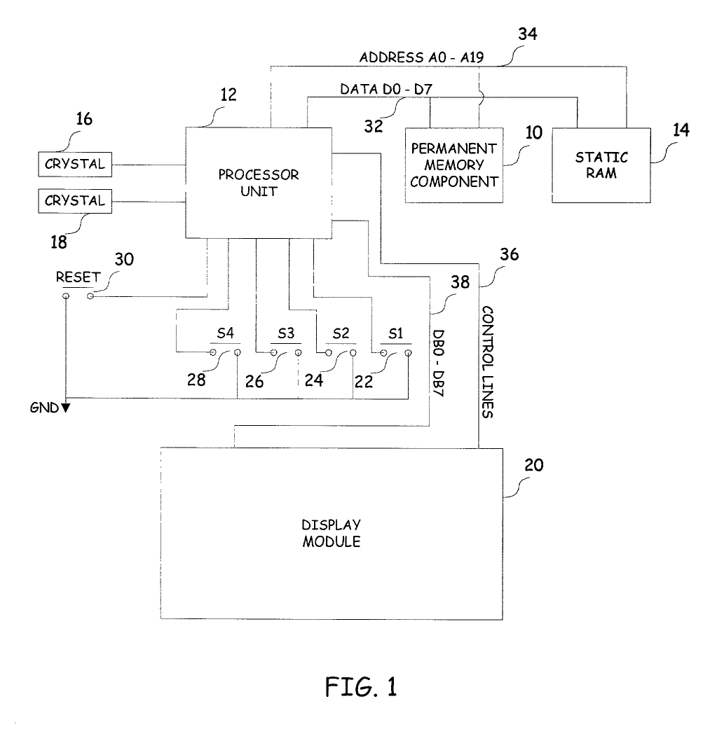

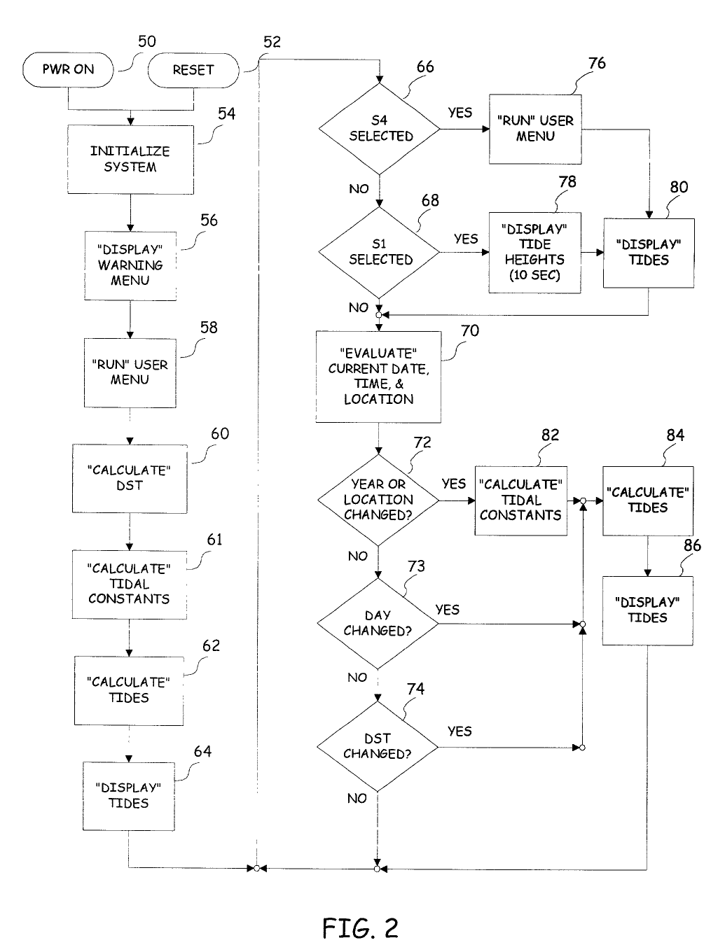

The present invention is a unique combination of my tidal prediction program based on the “Harmonic Analysis” method stored within permanent memory component 10 (FIG. 1) and an electronic circuit, usually a microprocessor based system (or equivalent). FIG. 1 depicts a block diagram of one of many forms of an electronic circuit capable of executing the program stored within memory 10. FIG. 2 is the general software execution flowchart for the program stored in memory 10. Actual program listing (machine-readable form) is provided on Compact Disc.

The tidal prediction program stored in memory 10 was developed using the “Harmonic Analysis” method as described in the “MANUAL OF HARMONIC ANALYSIS AND PREDICTION OF TIDES” Special Publication No. 98 published by the U.S. Department of Commerce. Program development solves the harmonic analysis mathematical equations predicting tidal times and heights for the selected locality using only the date and location supplied by the user in conjunction with stored harmonic data for the given locality. Integration of said software with the electronic circuit produces a device that will predict and display tidal times and heights without the need of any external reference to tidal data, meaning the electronic circuit that will execute the software will not require any technical data input by the user. The users will only be required to select the date, time, and locality in which the tides will be predicted and displayed. User interface with the system is via switches S1 through S4 (22, 24, 26, and 28) which are multifunction switches as defined by program execution. User will be notified as to the current function of the switches via the display module 20, or other visual means. The actual number of user interface switches can vary from that of FIG. 1 with slight modification to the hardware and software configuration.

The “MANUAL OF HARMONIC ANALYSIS AND PREDICTION OF TIDES” details the theory of tidal prediction. From said manual, page 2 paragraph 7, the harmonic analysis is based upon the assumption that the rise and fall of the tides in any locality can be expressed mathematically by the sum of a series of harmonic terms having certain relations to astronomical conditions. There are thirty-seven harmonic terms used in the summation. Software development provided a means of calculating all fundamental constants, formulas, and variables which are used in the computation of the tidal values thus eliminating the need to reference or include the tables contained in the “MANUAL OF HARMONIC ANALYSIS AND PREDICTION OF TIDES”. Benefits of calculation vice table inclusion are elimination of errors that can be introduced in the tidal predictions as a result of incorrect data input, tables only cover a finite time period which limits the timeframe of tidal predictions, and a reduction of required memory space in memory 10.

Prototype software development provided on Compact Disc was written and compiled using “Dynamic C 6.57R” English version Copyright Zworld Inc. Compiled program resides in memory 10. Modifications to the software may be required when used on systems based on a processor other than the RABBIT2000 processor or change to other hardware components such as a different type of display module 20.

Tidal prediction program listing (machine-readable form) is provided on Compact Disc. FIG. 2 is a block diagram illustrating a flowchart of the tidal prediction program listing in the most general form.

Program execution starts either when power is applied (block 50) or when reset switch 30 (block 52) is pressed.

System initializes (block 54). After initialization, warning menu (block 56) is displayed for ten seconds (time can be adjusted by programmer). After warning menu display clears the user-input menu (block 58) will be displayed. The user-input menu (block 58) requires the user to verify/set the time, date, and tidal locality.

Upon completion of user verification/setting of time, date and locality, Block 60 uses the input data to determine if Daylight Saving Time (DST) is in effect or not.

Tidal constants are then calculated (block 61) using the time, date, and location supplied by the user. Actual tide predictions are then calculated (block 62) by using the tidal constants, time, date, locality, and offsets, if required. Predictions are then displayed (block 64) on the display module 20.

A continuous loop now starts at (block 66) by first checking if switch S4 (28) has been selected or not. If switch S4 (28) has been selected (block 66 is a yes) will indicate that the user wants to run the user menu (block 76).

User menu (Block 76) allows setting/change to the time, date, and locality for the tidal prediction. Upon exiting the user menu (block 76) the previously calculated tidal information will once again be displayed (block 80) on display module 20 until evaluation of the current parameters (block 70) is accomplished.

If block 66 is a no, indicating that the user does not want to run the user menu (block 76), the program will look to see if switch S1 (22) is selected or not (block 68).

If block 68 indicates that S1 (22) has been selected (block 68 is a yes) then the tidal heights (block 78) will be displayed on display module 20 for fifteen seconds (time can be adjusted by programmer). After display period has expired the previously calculated tidal information will once again be displayed (block 80) on display module 20.

Upon completion of either decision block 68 or display tides (block 80) an evaluation of the current date, time and location (block 70) is performed. If the year or location has been changed (block 72 is a yes), tidal constants are recalculated (block 82). Actual tide predictions are then recalculated (block 84) by using the new tidal constants, time, date, locality, and offsets, if required. New predictions are then displayed (block 86) on the display module 20.

If the year or location has not been changed (block 72 is a no) then a check to see if the day has changed (block 73). If the day has changed (yes to block 73) then the tides are recalculated (block 84). New predictions are then displayed (block 86) on the display module 20.

If no change to the day (block 73 is a no), then a check to see if DST has changed (block 74). If DST was changed (block 74 is a yes) then once again the tides are recalculated (block 84) and new predictions are then displayed (block 86) on the display module 20.

Upon completion of decision block 72, block 73 and block 74 program execution loops back to block 66 to check if switch S4 (28) has been selected or not and continues from that point. The loop will continue until either power is secured or reset 30 is pressed. If reset 30 is depressed then execution will once again start at block 52 (reset).

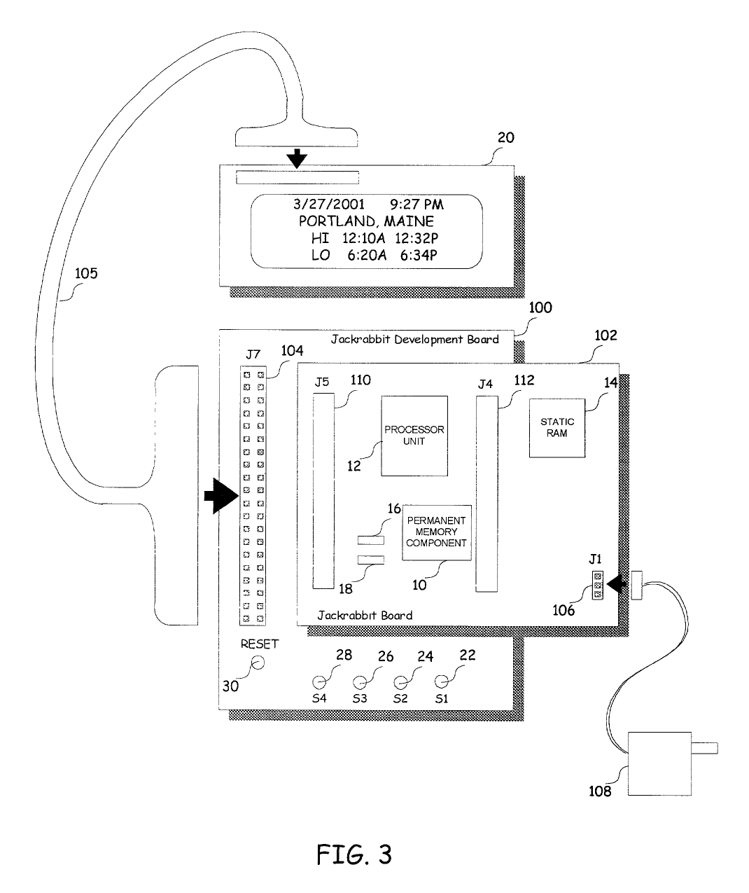

FIG. 3 depicts the construction and components used for the prototype system based on requirements of FIG. 1. Components used in the design of the prototype are now described. If hardware is used other than that described for the prototype system some modifications to the software and hardware configuration may be required.

Processor unit 12 on-chip specifications will vary but generally will contain a main oscillator, time/date oscillator, parallel I/O port or ports, serial I/O line or lines, and a Real Time Clock (RTC). An external RTC may be necessary if the processor does not contain a RTC. Prototype system uses the Rabbit 2000 Microprocessor manufactured by Rabbit Semiconductor, Davis California. Processor unit 12 will execute the software stored in permanent memory component 10 utilizing static memory 14 (RAM). Processor unit 12 generally requires two oscillator crystals (16 and 18), one to drive the RTC (Time/Date) and the other for program execution (Main Clock).

Processor unit 12 will execute tidal prediction software stored in permanent memory component 10. Results of the program execution will be displayed on display module 20. Display module 20 can vary depending on the application. Prototype system utilizes a Dot matrix LCD module manufactured by Optrex Corporation, part number DMC-20481-NYU-LY.

Depressing reset switch 30 will reset both hardware and software. This action will result in a system restart.

Processor unit 12 is connected to Flash Memory 10 and static RAM 14 via Data lines D0 through D7, 32, and address lines A0 through A19, 34. The processor unit 12 is connected to display module 20 via control lines, 36, and data lines, 38.

Prototype consists of the Rabbit 2000 Microprocessor Development Kit, manufactured by Rabbit Semiconductor, which consists of the Jackrabbit Development Board (part number 101-0343) 100 and the BL1810 Jackrabbit board (part number 101-0357) 102. Jackrabbit board 102 contains processor unit 12, permanent memory component 10, static memory 14, crystal 16 and crystal 18, and power input jack J1 (106). Wall transformer 108 will connect to jack J1 (106). Jackrabbit development board 100 contains, switches S1 through S4 (22, 24, 26, and 28), reset switch 30, and area for connector J7 (104). The Jackrabbit board 102 is attached to the Jackrabbit development board 100 by means of two connectors (J4 and J5) 110 and 112 located on Jackrabbit board to two corresponding sockets on the Jackrabbit development board 100.

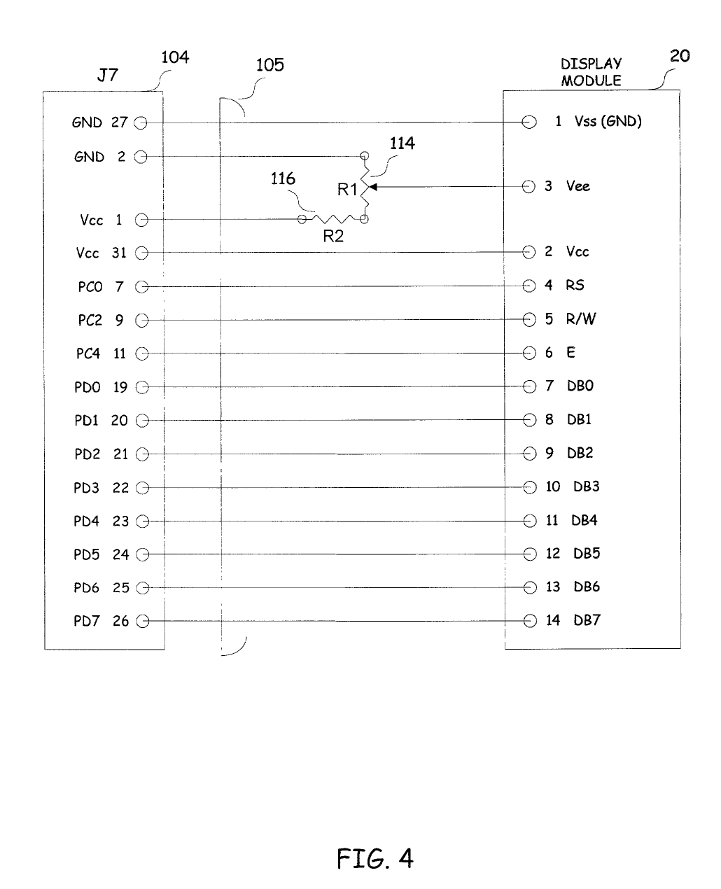

Rabbit2000 Microprocessor Development Kit was modified by adding connector J7 104 to the Jackrabbit Development Board 100. FIG. 4 details the connections made from the Jackrabbit Development board 100 to the display module 20. Variable resistor R1 (114) and resistor R2 (116) are provided for contrast adjustment to display module 20.

Algorithm that performs the Harmonic Analysis method for the prediction of tidal values, FIG. 2 block 62, is performed as follows. First step will be to determine the reference station for the selected locality. Next the tidal values for the reference station are calculated. Once the reference station values are known, the tidal values for the locality will be determined by using the offsets from the reference station. During the entire process listed above the software needs to track and adjust for Daylight Saving Time (DST) as well as offsets to reference station to ensure that the tidal predictions stay within the 24-hour time period of the prediction. Actual program listing (machine-readable form) provided on Compact Disc identifies how the software performs the tracking function.

Tidal values are determined by evaluating the harmonic equation for times of high and low waters to determine when the value is as close to zero as possible coupled with the slope of the line which will identify which tide (high or low) it is. Knowing the time of the zero point will determine if the tide is a morning or afternoon tide. Determination of the heights of the tides is then relatively simple by solving the harmonic equation for height of tide at any time using the times of high and low waters just determined.

FIG. 5 is one form of display that can display the date 120, time 122, location 124, High 126 and Low 128 morning and afternoon/evening tidal times.

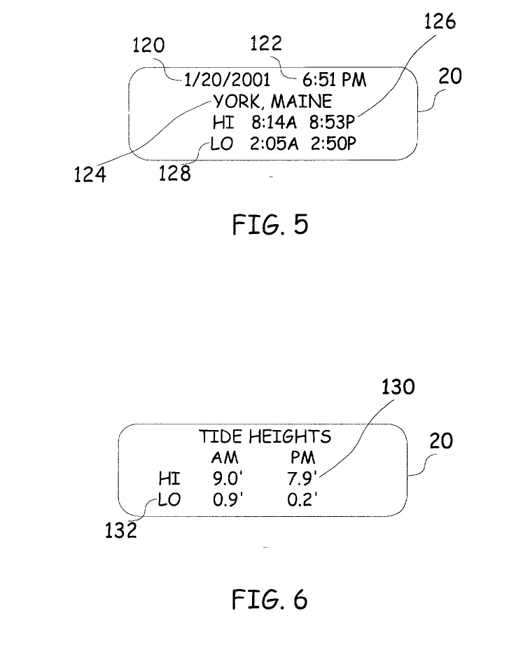

FIG. 6 is one form of display that can display the tidal heights (in feet) of Hi morning and afternoon 130 heights along with the Lo morning and afternoon 132 heights.

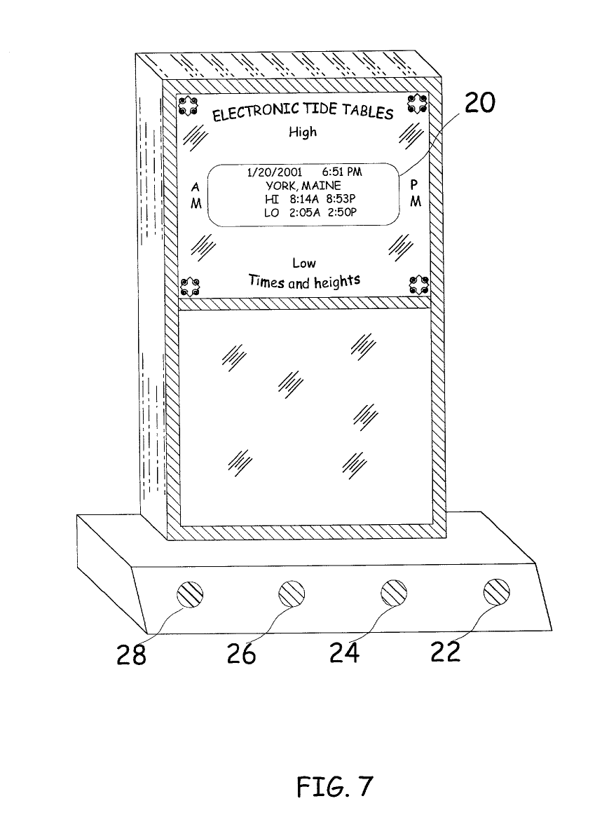

FIG. 7 is one of many possible display cases, which incorporates the display module 20 and switches S1 through S4 (22, 24, 26, and 28). The display case can be placed on a tabletop or may be hung on a wall.

Operation

The manner of using the Electronic Tide Tables is to simply apply power by attaching the wall transformer 108 to power input jack J1 (106). Wall transformer 108 is plugged into a wall receptacle. Once power has been applied the Electronic Tide Tables will initiate at FIG. 2 block 50.

The user will first see a warning menu (block 56) which will inform the user that the tide tables will be for recreational use, not for boating etc. The warning display will remain for a period of time specified by the programmer. Prototype has a display time of ten seconds for the warning menu.

Next the user will be required to verify, and change if necessary, the time, date, and locality for the tidal prediction via the user menu, block 58, and switches S1 (22), S2 (24), and S3 (26).

Once the user exits the user menu, block 58, no additional user interface is required until the user wants to change the time, date, or locality. The Electronic Tide Tables will automatically calculate the tides based on the user's information.

FIG. 5 is one form of display that can be displayed on the display module 20. Values that are available for display are the date 120, time 122, location 124, High 126 and Low 128 morning and afternoon/evening tidal times.

The user has only two options available while the Electronic Tide Tables is running. These options are selectable via switches S1 (22) and S4 (28). If the user presses and holds S1 (22) for one second the tide times display (FIG. 5) will be replaced with the tide heights display (FIG. 6). Tidal height display will contain the values (in feet) of Hi morning and afternoon 130 heights along with the Lo morning and afternoon 132 heights.

If the user presses and holds switch S4 (28) for one second the user menu will display at which point the user can once again change the time, date, and/or location for the tidal conditions to be predicted. Once the values are updated the program will calculate the tidal values if a change has occurred.

The above are the only user changeable items, unless the programmer adds additional user selectable features. All other information can only be changed by programmer modifications to the software stored in permanent memory 10.

Daylight saving time (DST) feature has been incorporated into the tidal prediction software. While the Electronic Tide Tables is operating, the software will evaluate the date and time of the Real Time Clock (RTC) to determine if the time needs to be adjusted due to DST. If the RTC is adjusted, then the tidal predictions also will require recalculation so that the tidal times will align to the time change. Programmer can eliminate or change the automatic DST feature so it is a menu option that the user can select if so desired.

When the real time clock advances to the next day, or DST change happens, the tidal predictions will be recalculated and the new values will be displayed. This will continue until the device is powered down.

### CONCLUSION, RAMIFICATIONS, AND SCOPE

Accordingly, the reader will see that the Electronic Tide Tables of this invention provide a reliable and accurate device that is simple to use by persons of almost any age.

While my above description contains many specifications, these should not be construed as limitations on the scope of the invention, but rather as an exemplification of one preferred embodiment thereof. Many other variations are possible. For example:

(a) the Electronic Tide Tables can be constructed with other processors

(b) different type of display units can be used to display the tidal information;

(c) enclosure that the electronics is housed in can be manufactured to suit the environment that the unit will be used in;

(d) modifications to the software can be made by a programmer in such a way that the tidal predictions are the same but the system operates more efficiently and/or user menus can be modified to add, subtract, or change features;

(e) a separate menu that will allow the user to predict future tidal values without changing RTC parameters;

(f) other almanac values such as sun rise and sun set, moon phases, etc. can be displayed;

(g) Global Position Systems (GPS) can be integrated into the device that determines the closest locality, then calculate and display the tidal values;

(h) future technology may enable new features, smaller packaging, etc. which will still produce the same predictions along with enhanced features;

Thus the scope of the invention should be determined by the appended claims and legal equivalents, rather than by the examples given.

I claim:

1) A device for predicting and displaying tidal times and heights for a plurality of locations and dates comprising a tidal prediction program residing within a storage component which is part of an electronic processing and display circuit.

2) The device of claim 1 wherein said tidal prediction program makes predictions for a plurality of locations for a selected date using the harmonic analysis method for the prediction of tides.

3) The device of claim 2 wherein said harmonic analysis method uses harmonic data comprising of thirty seven harmonic terms unique for each locality which are integrated into said program.

4) The device of claim 2 wherein said predictions are made for the reference station of the user selected locality.

5) The device of claim 4 wherein said reference station tidal predictions are adjusted by the locality offset values resulting in the prediction of tidal times and heights for the selected locality.

6) The device of claim 2 wherein said predictions values approximate the tidal predictions made by the National Oceanic and Atmospheric Administration.

7) The device of claim 1 wherein said tidal prediction program also includes a means of calculating all fundamental constants, formulas, and variables which are used in the computation of the tidal values thus eliminating the need to reference or include the tables.

8) The device of claim 1 wherein said electronic processing circuit is in electrical communication with said storage component comprising of a processor capable executing said tidal prediction program resulting in the prediction of tidal times and heights which are displayed.

9) The device of claim 8 wherein said display is in electrical communication with said electronic processing circuit for illustrating information comprising of tidal, locality, time, and date.

10) The device of claim 8 wherein said electronic processing circuit includes a plurality of switches and a real time clock which are in electrical communication with said electronic processing circuit and will interface with said tidal prediction program.

11) The device of claim 10 wherein said switches provides a mean for user interface with said tidal prediction program for purposes including changing the locality, time, date, and display information.

12) The device of claim 10 wherein said real time clock provides said tidal prediction program current time and date whereby the program will as a minimum:
(a) determine when the date has changed resulting in the recalculation of the prediction of tidal times and heights;
(b)tracks day light savings time and performs recalculation of the prediction of tidal times and heights when a change has occurred.

13) The device of claim 1 wherein said storage for said program is a permanent memory component.

14) The device of claim 1 wherein said electronic processing circuit is normally operating and is capable of displaying present time, date, locality for tidal prediction, and tidal predictions for selected date and location.

15) The device of claim 1 wherein said tidal prediction program contains all harmonic and technical data such that the user need only to select time, date, and location for tidal prediction.

16) The device of claim 1 wherein said tidal prediction program can be modified to include or exclude tidal localities limited only by size of said storage component.

17) The device of claim 1 wherein said tidal prediction program is capable of tidal predictions starting from year 1900 and beyond, limited only by parameters of said real time clock, which may cause start date to be later and or limit last year of predictions.

18) A method of providing predictions of tidal times and heights comprising of:
(a) a program embedded within a memory component which solves the harmonic analysis mathematical equations for the prediction of tidal times and heights using the unique harmonic data for locality reference station, by
(b) setting time and date for tidal prediction;
(c) factor in day light saving time if required;
(d) selecting locality for tidal prediction;
(e) identifying reference station for the selected locality;
(f) offset twenty four hour tidal prediction period such that final locality tidal times and associated heights will fall within the desired date when reference station adjustments are factored into predictions;
(g) determining tidal times and heights for reference station;
(h) adjust reference station tidal times and heights by the offset values for the locality where tidal values are desired;
(i) display tidal information for desired locality.
